(19) United States
(12) Patent Application Publication
(10) Pub. No.: US 2022/0140537 A1
(43) Pub. Date: May 5, 2022

(54) GROUNDING STRUCTURE AND CONNECTOR

(71) Applicant: DONGGUAN LUXSHARE TECHNOLOGIES CO., LTD, Dongguan City (CN)

(72) Inventor: Hongji CHEN, Dongguan City (CN)

(73) Assignee: DONGGUAN LUXSHARE TECHNOLOGIES CO., LTD, Dongguan City (CN)

(21) Appl. No.: 17/217,294

(22) Filed: Mar. 30, 2021

(30) Foreign Application Priority Data
Nov. 5, 2020 (CN) 202011225359.0

(51) Int. Cl. H01R 13/6471

(52) U.S. Cl. CPC H01R 13/6471; H01R 13/50

(57) ABSTRACT

Disclosed are a grounding structure and a connector. The grounding structure includes at least one first supporting portion, at least one second supporting portion and a plurality of contact arm structures. One end of each contact arm structure is securely connected to the first supporting portion, another end of the each contact arm structure is securely connected to the second supporting portion, and the contact arm structure is configured to be in electrical contact with a grounding terminal of a connector.

This application claims priority to Chinese Patent Application No. 202011225359.0 filed Nov. 5, 2020, the disclosure of which is incorporated herein by reference in its entirety

### TECHNICAL FIELD

The present disclosure relates to the technical field of electrical connectors, in particular, a grounding structure and a connector.

### BACKGROUND

A connector generally includes an insulating housing with an accommodating groove, a conductive terminal, and a grounding piece. The conductive terminal and the grounding piece are located in the insulating housing, and the conductive terminal includes a plurality of signal terminals and a plurality of grounding terminals. As shown in FIG. 27, a grounding piece 501 is provided with contact arms 502 for being in electrical contact with the respective grounding terminals, and the contact arm 502 is disposed at one end of the grounding piece 501 in a cantilever manner.

In the related art, the contact arm 502 is secured to one side of the grounding piece 501, one end of the contact arm 502 is securely connected to the grounding piece 501, another end of the contact arm 502 is an unconfined free end, the another end of the contact arm 502 is provided with a hook section 5021 bent towards the grounding terminal, and the hook section 5021 can abut against a conductive terminal. Since the another end of the contact arm 502 in contact with the grounding terminal is unconfined, the another end of the contact arm 502 is relatively prone to shake when the connector vibrates, resulting in poor stability of the contact arm 502.

### SUMMARY

An object of the present disclosure is to provide a grounding structure, which can improve the stability of a contact arm structure and further ensure the effect of the contact arm structure in electrical contact with a grounding terminal.

Another object of the present disclosure is further to provide a connector, which adopts a grounding structure with a higher stability, and thereby the grounding stability and reliability of the grounding terminal in the connector is improved and the high-frequency performance of the connector is ensured.

As conceived above, the present disclosure provides the solutions described below.

Provided is a grounding structure, including at least one first supporting portion, at least one second supporting portion and a plurality of contact arm structures.

One end of each contact arm structure is securely connected to the first supporting portion, another end of the each contact arm structure is securely connected to the second supporting portion, and the contact arm structure is configured to be in electrical contact with a grounding terminal of a connector.

Optionally, a middle portion of the each contact arm structure is convex, and middle portions of two of the plurality of contact arm structures are convex in a same direction or opposite directions.

Optionally, the first supporting portion is provided with one or more first openings, and/or the second supporting portion is provided with one or more first openings.

Optionally, every two adjacent contact arm structures form a second opening, and one of the one or more first openings is disposed corresponding to the second opening.

Optionally, the plurality of contact arm structures are connected to a first side of the first supporting portion, and a second side of the first supporting portion is provided with a material belt connecting portion.

Optionally, the at least one first supporting portion comprises one first supporting portion, the at least one second supporting portion comprises a plurality of second supporting portions, the plurality of second supporting portions are located on a same side of the one first supporting portion, and at least two contact arm structures are disposed between each second supporting portion and the one first supporting portion.

Optionally, two contact arm structures are disposed between the each second supporting portion and the one first supporting portion, a middle portion of the each contact arm structure is convex, and middle portions of the two contact arm structures are convex in opposite directions.

Optionally, the at least one second supporting portion comprises a plurality of second supporting portions, the at least one first supporting portion comprises one first supporting portion, the plurality of second supporting portions are disposed on two opposite sides of the first supporting portion, and the first supporting portion is connected to the plurality of second supporting portions through the plurality of contact arm structures.

Optionally, the at least one first supporting portion comprises two second supporting portions, the two second supporting portions are located on the two opposite sides of the first supporting portion, respectively, and at least two contact arm structures are disposed between each second supporting portion and the first supporting portion.

Optionally, a middle portion of the each contact arm structure is convex, and middle portions of the at least two contact arm structures are convex in a same direction.

Optionally, the grounding structure further includes an auxiliary supporting portion secured to a side portion of the first supporting portion.

Optionally, two sides of the first supporting portion and/or two sides of the second supporting portion are respectively provided with a limit structure.

Optionally, the first supporting portion, the second supporting portion and the plurality of contact arm structures are an integrated structure.

A connector provided includes an insulating housing, a conductive terminal and the above-mentioned grounding structure, where a mounting groove is disposed in the insulating housing, the conductive terminal and the grounding structure are disposed in the mounting groove, the plurality of contact arm structures are in electrical contact with a grounding terminal of the conductive terminal, and the first supporting portion and the second supporting portion respectively abut against a groove wall of the mounting groove.

Optionally, securing grooves are disposed on the groove wall of the mounting groove, the grounding structure further includes two auxiliary supporting portions secured to the two sides of the first supporting portion, respectively, and the two auxiliary supporting portions are secured in the securing grooves.

The present disclosure has advantageous effects described below.

The grounding structure provided by the present disclosure includes a first supporting portion, a second supporting portion and a contact arm structure. The contact arm structure is in electrical contact with a grounding terminal, and two ends of the contact arm structure are secured on the first supporting portion and the second supporting portion, respectively, so that the two ends of the contact arm structure are confined ends. Since the first supporting portion and the second supporting portion have a certain weight and a certain rigidity, when the connector vibrates, the vibration amplitude of the first supporting portion and the second supporting portion can be relatively small, so that the vibration amplitude of the contact arm structure can be smaller or even non-existent, thus the probability that the contact arm structure shakes is reduced, the stability of the contact arm structure is improved and the effect of the contact arm structure in electrical contact with the grounding terminal is ensured. Moreover, the grounding structure provided by the present disclosure is high in strength, so that the grounding structure is not prone to be broken during the vibration or the disassembly of the grounding structure, and the mounting and positioning of the grounding structure are facilitated through the set of a limit structure.

For the connector provided by the present disclosure, the grounding of the grounding terminal is achieved by adopting the above-mentioned grounding structure, the grounding stability and reliability of the grounding terminal are improved, the probability of the grounding failure of the connector is reduced, and the normal use of the connector is ensured. Since the grounding structure is simple, the cost of the connector adopting the grounding structure can be low. Moreover, the grounding structure has various shapes, the connector may be provided with one or more grounding structures according to actual requirements so as to be applicable for different technical fields and use scenarios, that is, the use scenarios and the application fields of the connector provided by the present disclosure are wide.

### BRIEF DESCRIPTION OF DRAWINGS

FIG. 1 is a front view of a grounding structure according to embodiment one of the present disclosure;

FIG. 2 is a perspective view of the grounding structure according to embodiment one of the present disclosure;

FIG. 3 is a front view of another grounding structure according to embodiment one of the present disclosure;

FIG. 4 is a perspective view of the another grounding structure according to embodiment one of the present disclosure;

FIG. 5 is a front view of still another grounding structure according to embodiment one of the present disclosure;

FIG. 6 is a side view of the still another grounding structure according to embodiment one of the present disclosure;

FIG. 7 is a perspective view of the still another grounding structure according to embodiment one of the present disclosure;

FIG. 8 is a front view of a grounding structure according to embodiment two of the present disclosure;

FIG. 9 is a side view of the grounding structure according to embodiment two of the present disclosure;

FIG. 10 is a perspective view of the grounding structure according to embodiment two of the present disclosure;

FIG. 11 is a front view of another grounding structure according to embodiment two of the present disclosure;

FIG. 12 is a perspective view of the another grounding structure according to embodiment two of the present disclosure;

FIG. 13 is a structural view of a connector according to embodiment three of the present disclosure;

FIG. 14 is an exploded view of the connector according to embodiment three of the present disclosure;

FIG. 15 is a top view of the connector according to embodiment three of the present disclosure;

FIG. 16 is a cross-sectional view of FIG. 15 taken along A-A;

FIG. 17 is a cross-sectional view of FIG. 15 taken along B-B;

FIG. 18 is a front view of the connector according to embodiment three of the present disclosure;

FIG. 19 is a cross-sectional view of FIG. 18 taken along C-C;

FIG. 20 is a structural view of another connector according to embodiment three of the present disclosure;

FIG. 21 is an exploded view of the another connector according to embodiment three of the present disclosure;

FIG. 22 is a top view of the another connector according to embodiment three of the present disclosure;

FIG. 23 is a cross-sectional view of FIG. 22 taken along D-D;

FIG. 24 is a cross-sectional view of FIG. 22 taken along E-E;

FIG. 25 is a perspective view of the another connector according to embodiment three of the present disclosure;

FIG. 26 is an enlarged view of position F in FIG. 25; and

FIG. 27 is a schematic view of a grounding piece and contact arms in the related art.

### REFERENCE LIST

1 first supporting portion
2 second supporting portion
3 contact arm structure
31 middle portion
4 auxiliary supporting portion
5 limit structure
10 first opening
20 second opening
30 engaging groove
100 insulating housing
101 mounting groove
1011 securing groove
200 conductive terminal
300 grounding structure
400 weld leg
501 grounding piece
502 contact arm
5021 hook section

### DETAILED DESCRIPTION

To make solved problems, adopted solutions and achieved effects of the present disclosure clearer, solutions of the present disclosure are further described below through embodiments in conjunction with drawings. It is to be understood that the embodiments described herein are merely intended to explain and not to limit the present disclosure. In addition, it should be noted that for ease of description, only the part related to the present disclosure, instead of all, is illustrated in the drawings.

In the description of the present disclosure, it should be noted that the orientations or position relations indicated by terms such as “center”, “above”, “below”, “left”, “right”, “vertical”, “horizontal”, “inside”, “outside” and the like are based on orientations or position relations shown in the drawings. These orientations or position relations are intended only to facilitate and simplify description of the present disclosure, and not to indicate or imply that a device or element referred to must have such specific orientations or must be configured or operated in such specific orientations. Thus, these orientations or position relations are not to be construed as limiting the present disclosure. In addition, terms such as “first” and “second” are used merely for the purpose of description and are not to be construed as indicating or implying relative importance.

In the description of the present disclosure, it should be noted that unless otherwise expressly specified and limited, the term “mounting”, “connected to each other” or “connected” is to be construed in a broad sense, for example, as securely connected or detachably connected; mechanically connected or electrically connected; directly connected to each other or indirectly connected to each other via an intermediary; or internally connected between two elements. For those of ordinary skill in the art, specific meanings of the preceding terms in the present disclosure may be construed based on specific situations.

### Embodiment One

This embodiment provides a grounding structure, which can improve the stability of a contact arm structure and further ensure the effect of the contact arm structure in electrical contact with a grounding terminal.

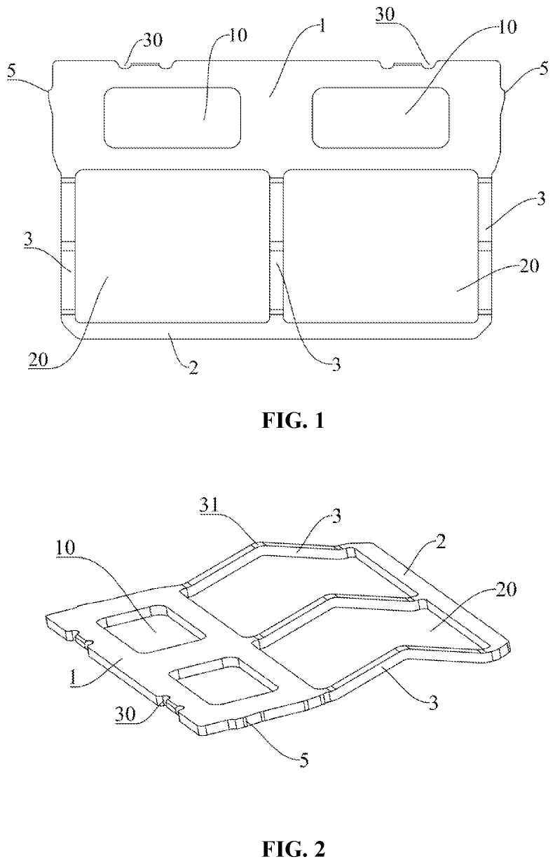

As shown in FIGS. 1 to 7, the grounding structure includes a first supporting portion 1, a second supporting portion 2 and a contact arm structure 3, where the first supporting portion 1 and the second supporting portion 2 are disposed opposite to each other. A plurality of contact arm structures 3 are provided, one end of each contact arm structure 3 is securely connected to the first supporting portion 1, another end of each contact arm structure 3 is securely connected to the second supporting portion 2, and the contact arm structure 3 is in electrical contact with a grounding terminal of a connector.

The grounding structure provided by this embodiment includes the first supporting portion 1, the second supporting portion 2 and the contact arm structure 3. The contact arm structure 3 is in electrical contact with a grounding terminal, and two ends of the contact arm structure 3 are secured on the first supporting portion 1 and the second supporting portion 2, respectively, such that the two ends of the contact arm structure 3 are confined ends. Since the first supporting portion 1 and the second supporting portion 2 have a certain weight and a certain rigidity, when the connector vibrates, the vibration amplitude of the first supporting portion 1 and the vibration amplitude of the second supporting portion 2 can be relatively small, so that the vibration amplitude of the contact arm structure 3 can be smaller or even non-existent, thus the probability that the contact arm structure 3 shakes is reduced, the stability of the contact arm structure 3 is improved and the effect of the contact arm structure 3 in electrical contact with the grounding terminal is ensured.

In this embodiment, the first supporting portion 1 is provided with a first side and a second side, and, as shown in FIG. 1 or FIG. 2, the plurality of contact arm structures 3 are all connected to the first side of the first supporting portion 1, that is, the plurality of contact arm structures 3 are disposed on the same side of the first supporting portion 1, and the plurality of contact arm structures 3 may be disposed at equal intervals.

Further, as shown in FIG. 1, the second side of the first supporting portion 1 is provided with a material belt connecting portion 30 which is a portion where the material belt is connected. The material belt connecting portion 30 is used for separating the material belt from the grounding structure by bending the material belt after the material belt is inserted into the grounding structure. Exemplarily, the material belt connecting portion 30 is groove-shaped.

Optionally, as shown in FIGS. 1 to 4, a middle portion of the contact arm structure 3 is convex, that is, the middle portion of the contact arm structure 3 is convex relative to the two ends of the contact arm structure 3, and the convex middle portion of the contact arm structure 3 is used to be in electrical contact with the grounding terminal so as to ensure the contact effect between the contact arm structure 3 and the grounding terminal. Moreover, the middle portions of two of the plurality of contact arm structures 3 are convex in the same direction so as to be applicable to a usage scenario where the ground terminals are disposed on one side of the ground structure. Exemplarily, the middle portions of the plurality of contact arm structures 3 shown in FIGS. 1 to 4 are all convex in the same direction.

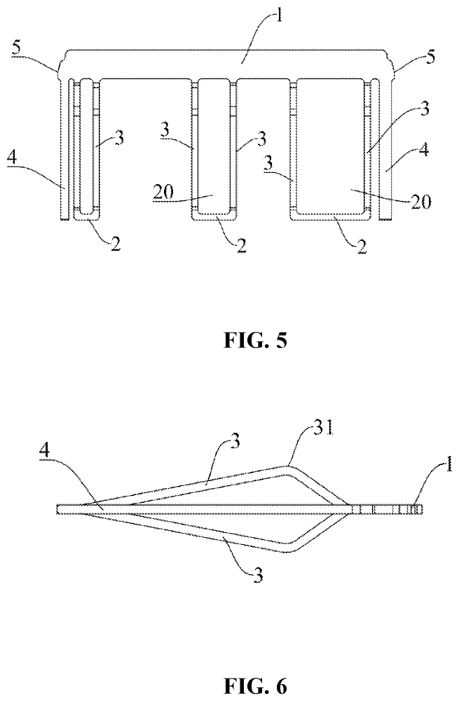

Different from the middle portions of the contact arm structures 3 shown in FIGS. 1 to 4, middle portions of two of the plurality of contact arm structures 3 shown in FIGS. 5 to 7 are convex in opposite directions, that is, a part of the plurality of middle portions of the plurality of contact arm structures 3 are convex upwards, and another part of the plurality of middle portions of the plurality of contact arm structures 3 are convex downwards, so as to be applicable to a usage scenario where ground terminals are disposed on two sides of the ground structure. Exemplarily, in FIGS. 5 to 7, the grounding structure includes six contact arm structures 3, and middle portions of any two adjacent contact arm structures 3 are convex in different directions.

Further, as shown in FIGS. 5 to 7, one first supporting portion 1 is provided, a plurality of second supporting portions 2 are provided, the plurality of the second supporting portions 2 are all located on the same side of the first supporting portion 1 (i.e., the first side of the first supporting portion 1), and at least two contact arm structures 3 are disposed between each second supporting portion 2 and the first supporting portion 1.

Further, two contact arm structures 3 are disposed between each second supporting portion 2 and the first supporting portion 1, the middle portion of each contact arm structure 3 is convex, and the middle portions of the two contact arm structures 3 are convex in opposite directions.

Optionally, as shown in FIGS. 1 to 4, the first supporting portion 1 is provided with one or more first openings 10, and/or the second supporting portion 2 is provided with one or more first openings 10. The first openings 10 are configured to avoid signal terminals to improve the high-frequency performance.

Further, a respective second opening 20 is formed between two adjacent contact arm structures, the number of the second openings 20 is the same as the number of the first openings 10, and the first openings 10 may be disposed corresponding to the second openings 20. The second openings 20 are also configured to avoid the signal terminals to improve the high-frequency performance.

Optionally, as shown in FIG. 5, the lengths of the second supporting portions 2 may be different, and two contact arm structures 3 are connected to two ends of the respective second supporting portion 2 so that the first supporting portion 1, the contact arm structures 3 and the second supporting portions 2 form second openings of different sizes to satisfy the requirements of different connectors.

In the embodiment, the first opening 10 and the second opening 20 are disposed according to actual requirements, as shown in FIG. 5, the first supporting portion 1 is provided with no first opening 10, while a respective second opening 20 is formed between two adjacent contact arm structures 3, and, the second openings 20 do not need to be disposed corresponding to the first opening 10.

Optionally, as shown in FIG. 5, the grounding structure may further include an auxiliary supporting portion 4. The auxiliary supporting portion 4 is secured to a side portion of the first supporting portion 1 and is configured to provide support on an insulating housing 100 of the connector to improve the stability of the grounding structure in the insulating housing 100. The first side and second side of the first supporting portion 1 are two sides of the first supporting portion 1 in a first direction, the side portion of the first supporting portion 1 is a side surface of the first supporting portion 1 in a second direction, and the second direction is located on the same horizontal plane as the first direction and is perpendicular to the first direction. Exemplarily, the first direction may be the width direction of the first supporting portion 1 and the second direction may be the length direction of the first supporting portion 1. Exemplarily, two sides of the first supporting portion 1 in the second direction are respectively provided with an auxiliary supporting portion 4.

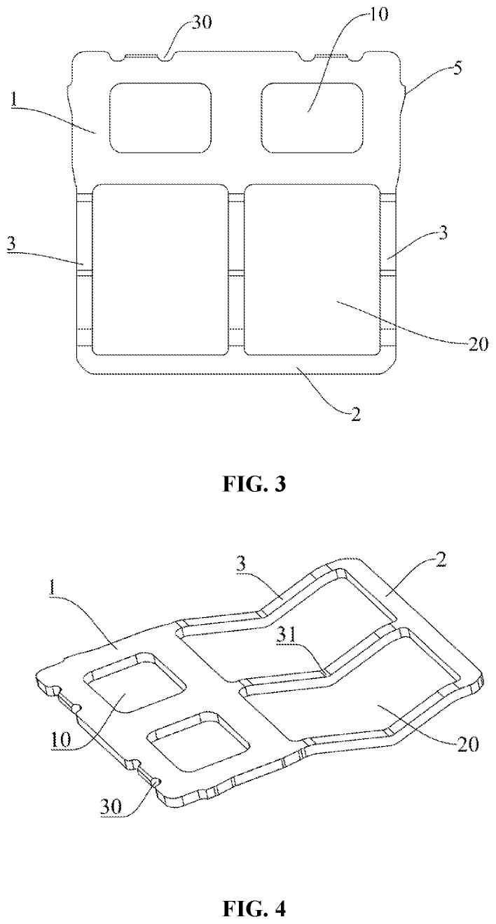

Optionally, as shown in FIG. 3, two sides of the first supporting portion 1 in the second direction and/or two sides of the second supporting portion 2 in the second direction are respectively provided with a limit structure 5. The limit structure 5 protrudes relative to the first supporting portion 1 or the second supporting portion 2 and is used to be in interference fit with the groove on the insulating housing 100 to facilitate positioning of the grounding structure and ensure the stability of the grounding structure in the insulating housing 100. Optionally, when the first supporting portion 1 is provided with the auxiliary supporting portion 4, the limit structure 5 may further be secured on the first supporting portion 1 and the auxiliary supporting portion 4 in a straddling manner.

In the embodiment, the first supporting portion 1, the second supporting portion 2 and the plurality of contact arm structures 3 are an integrated structure, that is, the first supporting portion 1, the second supporting portion 2 and the plurality of contact arm structures 3 may be formed in one manufacturing process. Moreover, the first supporting portion 1, the second supporting portion 2 and the plurality of contact arm structures 3 are made of metal materials. Further, the limit structure 5 and the first supporting portion 1 may further be an integrated structure.

Optionally, the dimensions of the first supporting portion 1, the second supporting portion 2 and the contact arm structure 3 may be determined according to practical requirements. Exemplarily, the grounding structure shown in FIG. 1 is wider than the grounding structure shown in FIG. 3, and the grounding structures shown in FIGS. 1 and 3 may be applied to a connector of model SFF-8482. As shown in FIG. 14, the connector includes a ground structure shown in FIG. 1 and a ground structure shown in FIG. 3.

It should be noted that as shown in FIG. 27, in the related art, the contact arm 502 is secured to one side of the grounding piece 501, one end of the contact arm 502 is securely connected to the grounding piece 501, the other end of the contact arm 502 is an unconfined free end, the other end of the contact arm 502 is provided with a hook section 5021 bent towards a grounding terminal, and the hook section 5021 can abut against a conductive terminal. Since the contact arm 502 needs to be in elastic contact with the grounding terminal, the contact arm 502 cannot abut against the insulating housing and can be secured on the insulating housing only through the grounding piece 501 to ensure the stability between the grounding piece 501 and the contact arm 502; when the strength of the grounding piece secured on the insulating housing is insufficient, the grounding piece 501 is relatively prone to move relative to the insulating housing, so that the contact arm 502 is driven to move relative to the grounding terminal, the contact between the contact arm 502 and the grounding terminal is unstable, the risk that the contact arm 502 cannot be in electrical contact with the grounding terminal exists, and the normal use of the connector is affected.

For the grounding structure provided by this embodiment, two ends of the contact arm structure 3 are secured on the first supporting portion 1 and the second supporting portion 2, respectively, so that the contact arm structure 3 can be secured on the insulating housing 100 through the first supporting port 1 and the second supporting port 2. When the strength of one of the first supporting portion 1 and the second supporting portion 2 secured on the insulating housing 100 is insufficient, the contact arm structure 3 can be stably secured on the insulating housing 100 through another one of the first supporting portion 1 and the second supporting portion 2, so that the stability of the contact arm structure 3 in contact with the grounding terminal can also be ensured, the risk that the contact arm structure 3 cannot be in contact with the grounding terminal is reduced, and the normal use of the connector is ensured.

In addition, in the related art, as shown in FIG. 27, the contact arm 502 is secured to one side of the grounding piece 501, one end of the contact arm 502 is securely connected to the grounding piece 501, the other end of the contact arm 502 is an unconfined free end and provided with a hook section 5021 bent towards the grounding terminal, and the hook section 5021 can abut against a conductive terminal. Since mounting errors exit when the grounding terminal is being mounted in the insulating housing, it is necessary to adjust the position of the grounding piece according to the position of the grounding terminal, such as adjusting the abutting position of the grounding piece 501 and the insulating housing, but the insulating housing can only limit the position of one grounding piece 501, so that the grounding piece 501 and the contact arm 502 have a small adjustable range and a low flexibility.

For the grounding structure provided by this embodiment, two ends of the contact arm structure 3 are secured on the first supporting portion 1 and the second supporting portion 2, respectively. When the position of the contact arm structure 3 needs to be adjusted, the position of the first supporting portion 1 and position of the second supporting portion 2 on the insulating housing may be respectively adjusted and limited so as to precisely adjust the position of the contact arm structure 3, so that the contact arm structure 3 can be in better contact with the grounding terminal, the adjusting range of the grounding structure is enlarged, and the flexibility of the grounding structure is improved.

### Embodiment Two

The grounding structure of this embodiment differs from the grounding structure of embodiment one in that two sides of the first supporting portion 1 are both provided with a second supporting portion 2.

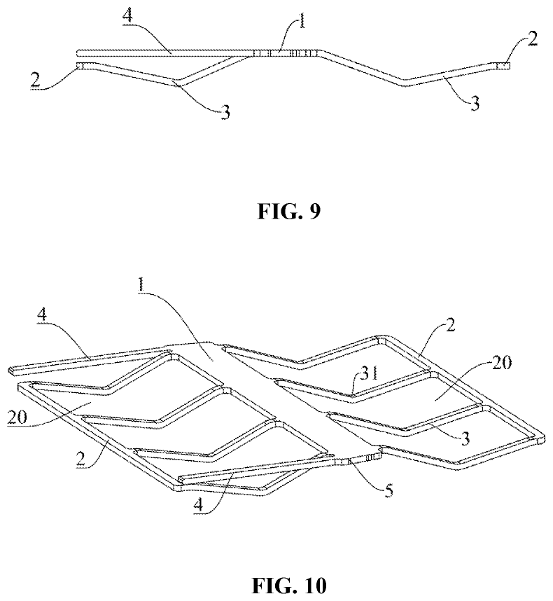

In an embodiment, as shown in FIGS. 8 to 12, a plurality of the second supporting portions 2 are provided, and one first supporting portion 1 is provided. Two opposite sides of the first supporting portion 1 (i.e. a first side and a second side of the first supporting portion 1) are respectively provided with the second supporting portion 2, and the first supporting portion 1 is securely connected to each second supporting portion 2 through the contact arm structures 3, that is, a part of the plurality of contact arm structures 3 are located on the first side of the first supporting portion 1 and are securely connected to the second supporting portion 2 located on the first side of the first supporting portion 1, and the other part of the plurality of contact arm structures 3 are located on the second side of the first supporting portion 1 and are securely connected to the second supporting portion 2 located on the second side of the first supporting portion 1.

Further, two second supporting portions 2 are provided, the two second supporting portions 2 are located on the two opposite sides of the first supporting portion 1, respectively, and at least two contact arm structures 3 are disposed between each second supporting portion 2 and the first supporting portion 1.

Optionally, as shown in FIG. 10, a middle portion of the contact arm structure 3 is convex, and the middle portions of at least two contact arm structures 3 are convex in the same direction.

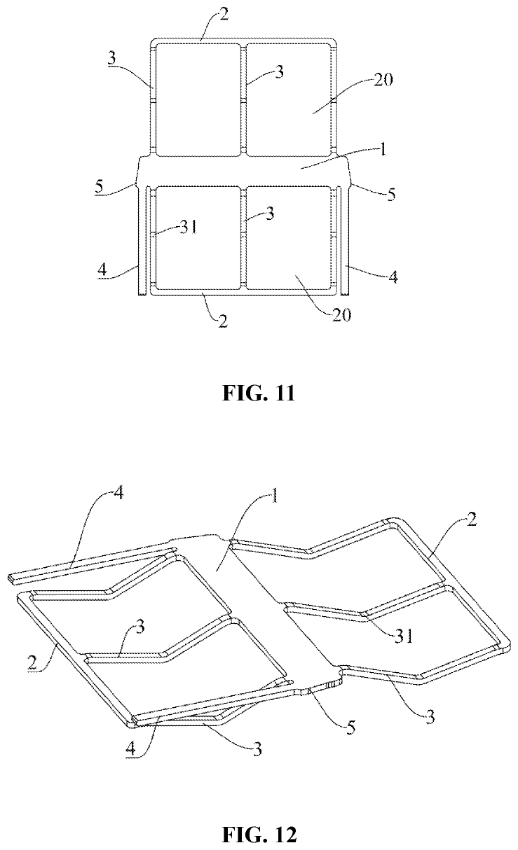

In this embodiment, the number of the contact arm structures 3 on the two sides of the first supporting portion 1 may be determined according to product requirements, as shown in FIG. 8, the two sides of the first supporting portion 1 are respectively connected with four contact arm structures 3, and the four contact arm structures 3 on the first side of the first supporting portion 1 are disposed opposite to and in one-to-one correspondence to the four contact arm structures 3 on the second side of the first supporting portion 1. Alternatively, as shown in FIG. 11, the two sides of the first supporting portion 1 are respectively connected with three contact arm structures 3, which is not limited in this embodiment.

The other structures in this embodiment are the same as the corresponding structures in embodiment one, for example, the grounding structure also includes the auxiliary supporting portion 4 and the limit structure 5, which will not be repeated herein.

### Embodiment Three

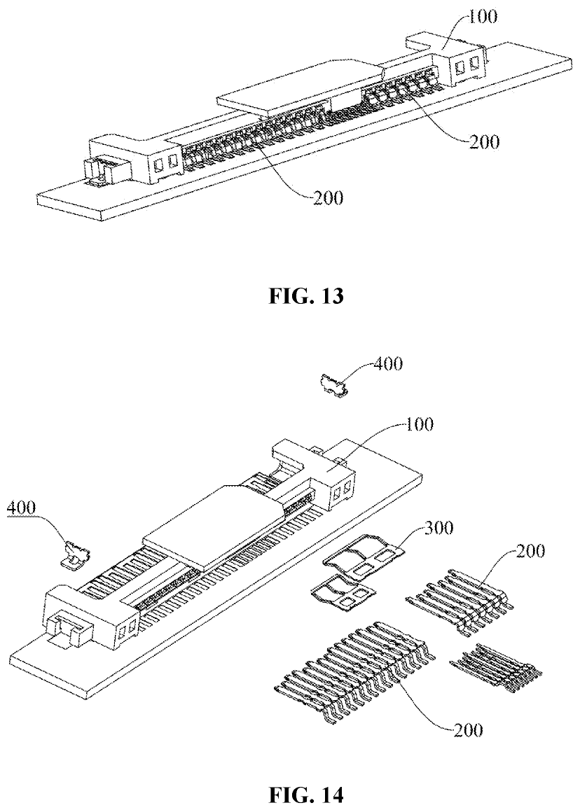

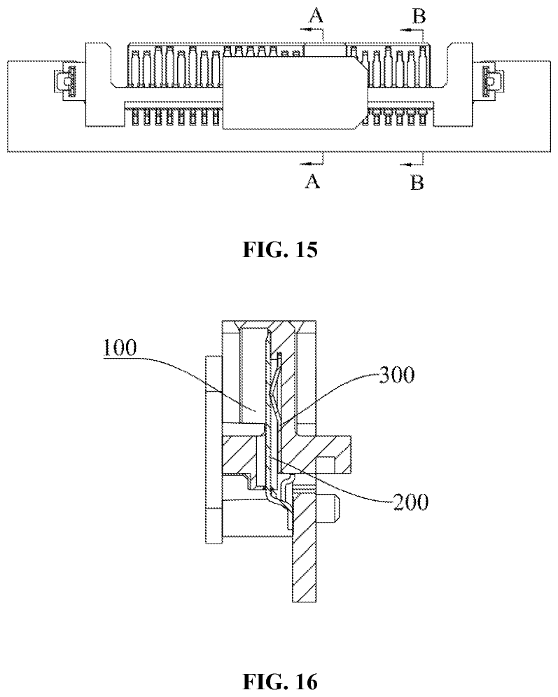

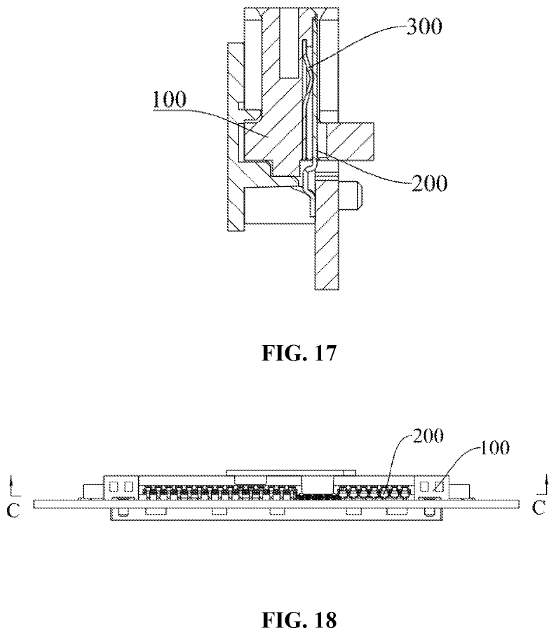

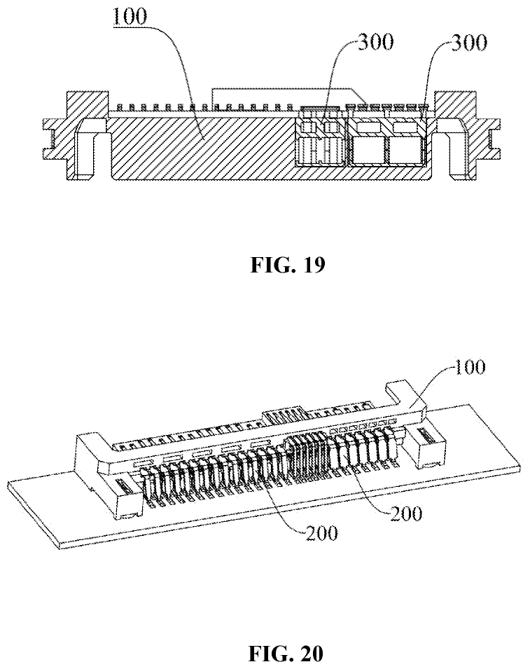

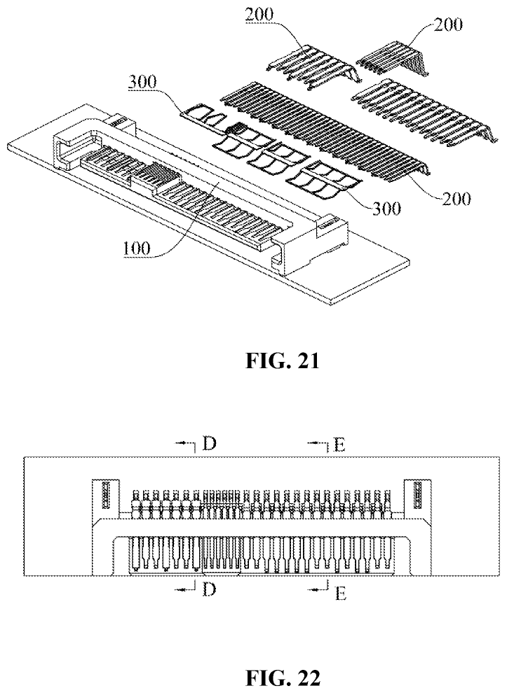

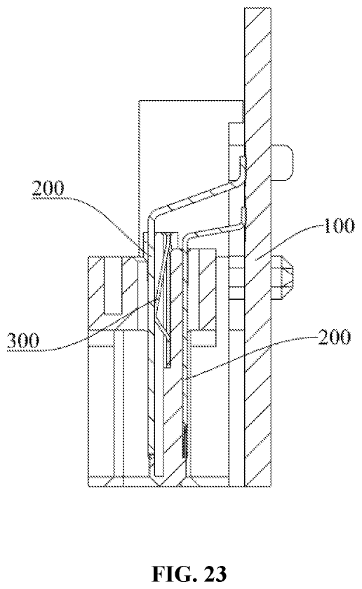

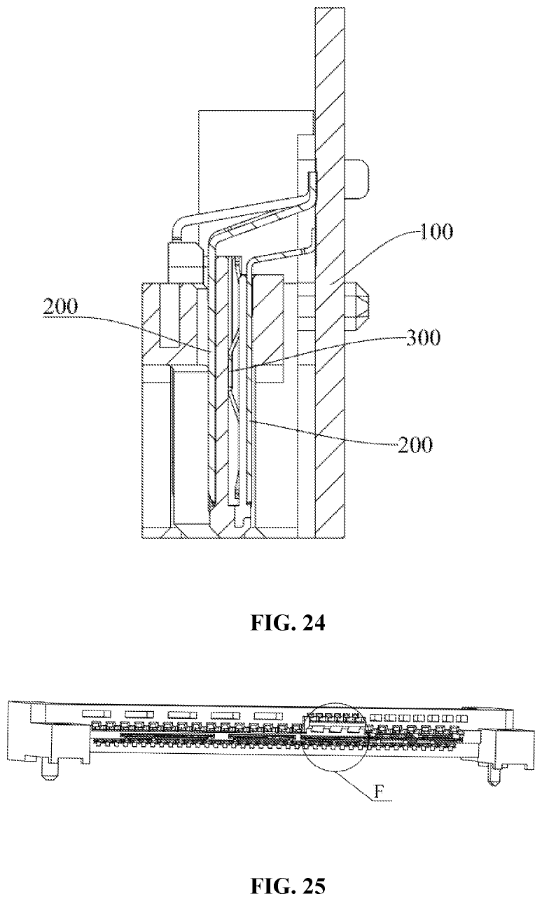

This embodiment further provides a connecter. As shown in FIGS. 13 to 26, the connector includes an insulating housing 100, a conductive terminal 200 and the grounding structure 300 of embodiment one and embodiment two, that is, the connector may only include the grounding structure 300 of embodiment one, may only include the grounding structure 300 of embodiment two, and may also include both the grounding structure 300 of embodiment one and the grounding structure 300 of embodiment two. A mounting groove 101 is disposed in the insulating housing 100, the conductive terminal 200 and the grounding structure 300 are disposed in the mounting groove 101, the contact arm structure 3 is in electrical contact with a grounding terminal in the conductive terminal 200, and the first supporting portion 1 and the second supporting portion 2 respectively abut against a groove wall of the mounting groove 101.

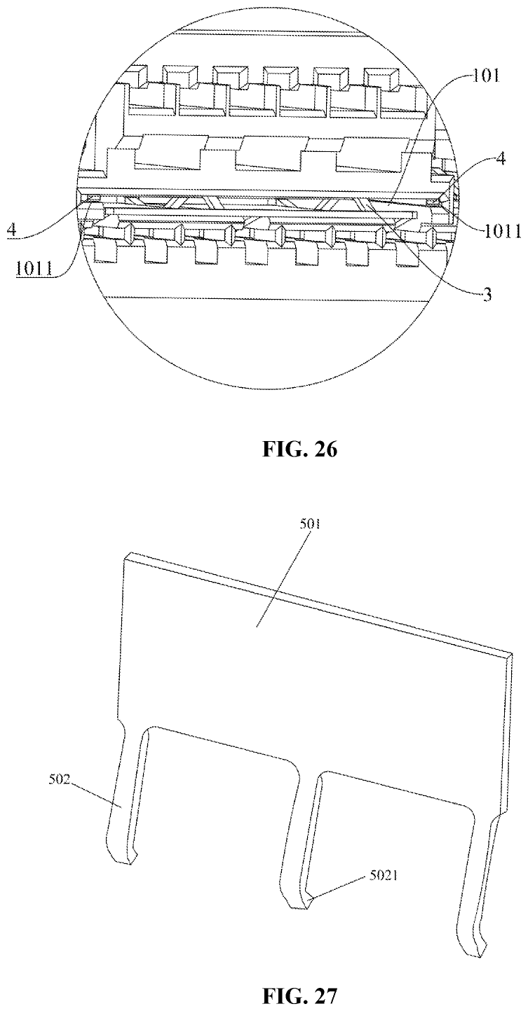

Further, as shown in FIG. 26, securing grooves 1011 are disposed on the groove wall of the mounting groove 101, the grounding structure 300 further includes two auxiliary supporting portions 4 secured to two sides of the first supporting portion 1, respectively, and the two auxiliary supporting portions 4 are secured in the securing grooves 1011, thus improving the stability of the grounding structure 300 in the insulating housing 100.

Optionally, as shown in FIG. 14, the connector further includes a weld leg 400, which is inserted into the insulating housing 100.

In the embodiment, FIGS. 14 to 19 are schematic views of a connector, where the connector includes two grounding structures 300 which are the grounding structure 300 shown in FIG. 1 and grounding structure 300 shown in FIG. 3 in electrical contact with different grounding terminals, respectively.

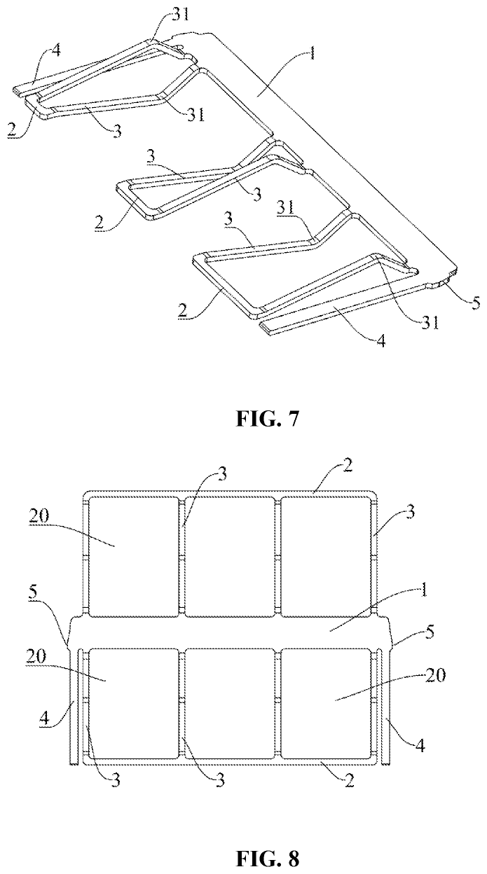

FIGS. 20 to 26 are schematic views of a connector, where the connector includes a grounding structure 300 shown in FIG. 7, a grounding structure 300 shown in FIG. 10 and two grounding structures 300 shown in FIG. 11.

For the connector provided by this embodiment, the grounding of the grounding terminal is achieved by adopting the above grounding structures 300, the grounding stability and reliability of the grounding terminal are improved, the probability of the grounding failure of the connector is reduced, and the normal use of the connector is ensured. Since the grounding structure 300 is simple, the cost of the connector adopting the grounding structure 300 can be low. Moreover, the grounding structure 300 has various shapes, the connector may be provided with one or more grounding structures 300 according to actual requirements so as to be applicable for different technical fields and use scenarios, that is, the use scenarios and the application fields of the connector provided by the present disclosure are wide.

The above embodiments describe only the basic principles and characteristics of the present disclosure and the present disclosure is not limited to the above embodiments. Various modifications and changes may be made in the present disclosure without departing from the spirit and scope of the present disclosure. These modifications and changes fall within the scope of the present disclosure. The scope of the present disclosure is defined by the appended claims and equivalents thereof.

What is claimed is:

1. A grounding structure, comprising:
at least one first supporting portion;
at least one second supporting portion; and
a plurality of contact arm structures, wherein one end of each contact arm structure is securely connected to the first supporting portion, another end of the each contact arm structure is securely connected to the second supporting portion, and the contact arm structure is configured to be in electrical contact with a grounding terminal of a connector.

2. The grounding structure according to claim 1, wherein a middle portion of the each contact arm structure is convex, and middle portions of two of the plurality of contact arm structures are convex in a same direction or opposite directions.

3. The grounding structure according to claim 1, wherein the first supporting portion is provided with one or more first openings, and/or, the second supporting portion is provided with one or more first openings.

4. The grounding structure according to claim 3, wherein every two adjacent contact arm structures form a second opening, and one of the one or more first openings is disposed corresponding to the second opening.

5. The grounding structure according to claim 4, wherein the plurality of contact arm structures are connected to a first side of the first supporting portion, and a second side of the first supporting portion is provided with a material belt connecting portion.

6. The grounding structure according to claim 1, wherein the at least one first supporting portion comprises one first supporting portion, the at least one second supporting portion comprises a plurality of second supporting portions, the plurality of second supporting portions are located on a same side of the one first supporting portion, and at least two contact arm structures are disposed between each second supporting portion and the one first supporting portion.

7. The grounding structure according to claim 6, wherein two contact arm structures are disposed between the each second supporting portion and the one first supporting portion, a middle portion of the each contact arm structure is convex, and middle portions of the two contact arm structures are convex in opposite directions.

8. The grounding structure according to claim 1, wherein the at least one second supporting portion comprises a plurality of second supporting portions, the at least one first supporting portion comprises one first supporting portion, the plurality of second supporting portions are disposed on two opposite sides of the first supporting portion, respectively, and the first supporting portion is connected to the plurality of second supporting portions through the plurality of contact arm structures.

9. The grounding structure according to claim 8, wherein the at least one first supporting portion comprises two second supporting portions, the two second supporting portions are located on the two opposite sides of the first supporting portion, respectively, and at least two contact arm structures are disposed between each second supporting portion and the first supporting portion.

10. The grounding structure according to claim 9, wherein a middle portion of the each contact arm structure is convex, and middle portions of the at least two contact arm structures are convex in a same direction.

11. The grounding structure according to claim 1, further comprising an auxiliary supporting portion secured to a side portion of the first supporting portion.

12. The grounding structure according to claim 1, wherein two sides of the first supporting portion and/or two sides of the second supporting portion are respectively provided with a limit structure.

13. The grounding structure according to claim 1, wherein the first supporting portion, the second supporting portion and the plurality of contact arm structures are an integrated structure.

14. A connector, comprising an insulating housing, a conductive terminal and a grounding structure, wherein the grounding structure comprises:
at least one first supporting portion;
at least one second supporting portion; and
a plurality of contact arm structures, wherein one end of each contact arm structure is securely connected to the first supporting portion, another end of the each contact arm structure is securely connected to the second supporting portion, and the contact arm structure is configured to be in electrical contact with a grounding terminal of a connector,
wherein a mounting groove is disposed in the insulating housing, the conductive terminal and the grounding structure are disposed in the mounting groove, the plurality of contact arm structures are in electrical contact with a grounding terminal of the conductive terminal, and the first supporting portion and the second supporting portion respectively abut against a groove wall of the mounting groove.

15. The connector according to claim 14, wherein securing grooves are disposed on the groove wall of the mounting groove, the grounding structure further comprises two auxiliary supporting portions secured to two sides of the first supporting portion, respectively, and the two auxiliary supporting portions are secured in the securing grooves.

16. The connector according to claim 14, wherein a middle portion of the each contact arm structure is convex, and middle portions of two of the plurality of contact arm structures are convex in a same direction or opposite directions.

17. The connector according to claim 14, wherein the first supporting portion is provided with one or more first openings, and/or, the second supporting portion is provided with one or more first openings.

18. The connector according to claim 17, wherein every two adjacent contact arm structures form a second opening, and one of the one or more first openings is disposed corresponding to the second opening.

19. The connector according to claim 18, wherein the plurality of contact arm structures are connected to a first side of the first supporting portion, and a second side of the first supporting portion is provided with a material belt connecting portion.

20. The connector according to claim 14, wherein the at least one first supporting portion comprises one first supporting portion, the at least one second supporting portion comprises a plurality of second supporting portions, the plurality of second supporting portions are located on a same side of the one first supporting portion, and at least two contact arm structures are disposed between each second supporting portion and the one first supporting portion.
